(19) United States
(12) Patent Application Publication
(10) Pub. No.: US 2004/0182259 A1
(43) Pub. Date: Sep. 23, 2004

(54) Culinary utensil

(75) Inventor: Ignaz Settele, Kaufbeuren (DE)

Correspondence Address: OSTROLENK FABER GERB & SOFFEN, 1180 AVENUE OF THE AMERICAS, NEW YORK, NY, 100368403

(73) Assignee: Maxpat Trading & Marketing (Far East) Limited

(21) Appl. No.: 10/767,714

(22) Filed: Jan. 28, 2004

(30) Foreign Application Priority Data
Jan. 28, 2003 (GB) 0301959.3

(51) Int. Cl. A23N 7/00

(52) U.S. Cl. 99/588

(57) ABSTRACT

A culinary utensil provided with a first cutting means in the form of a series of spaced cutting teeth arranged on a first cutting member spaced in a lateral direction, and a second cutting means arranged close to the first cutting means in the form of an elongate cutting edge which extends in the lateral direction.

The present invention relates to a culinary utensil.

When preparing food for cooking or consumption, it is often necessary to cut items of food into long strips commonly referred to as “julienne”. For example, it is common that vegetables such as carrots are prepared in the form of a julienne for use in making a salad. Typically, one would use a simple knife to cut the food into relatively thin layers of the food, and then secondly cut the layers into the thin strips of the julienne. This is a time consuming operation. Electrical culinary appliances have been proposed to produce strips of foodstuffs more easily although they are of limited effectiveness and often complicated, bulky and require washing of the cutting parts after use.

It is thus an object of the present invention to provide a single culinary utensil with which preparing strips of foodstuffs will become much more effective and less time consuming, or at least to provide a useful alternative to the food-preparing public.

According to the present invention, there is provided a culinary utensil provided with a first cutting means in the form of a series of spaced cutting teeth arranged on a first cutting member spaced in a lateral direction, and a second cutting means arranged close to the first cutting means in the form of an elongate cutting edge which extends in the lateral direction. The provision of the first cutting means and the second cutting means allows the preparation of the long thin strips of the foodstuffs with one utensil in one simple operation.

Preferably, the first and second cutting means may both be arranged on the first cutting member. In particular, the first cutting member may be provided with an opening arranged along the length thereof, with the first and second cutting means on opposite sides of the opening.

Suitably, the cutting teeth may be of thin profile when viewed in a direction perpendicular to the lateral direction.

Advantageously, the teeth may be unitarily formed with the first cutting member, being bent downwardly therefrom.

The first cutting member may preferably be secured at opposite ends on the utensil to allow limited pivoting moment.

Suitably, the utensil may have an elongate handle and a U-shaped support on which the first cutting member is pivotally mounted.

Advantageously, a second elongate member may be provided on the U-shaped support formed with at least one cutting edge. The second member may have two opposed cutting edges on opposite sides of an opening. The second member may be elongate in shape.

An embodiment of the present invention will now be described, by way of example only, with reference to the accompany drawings, in which:

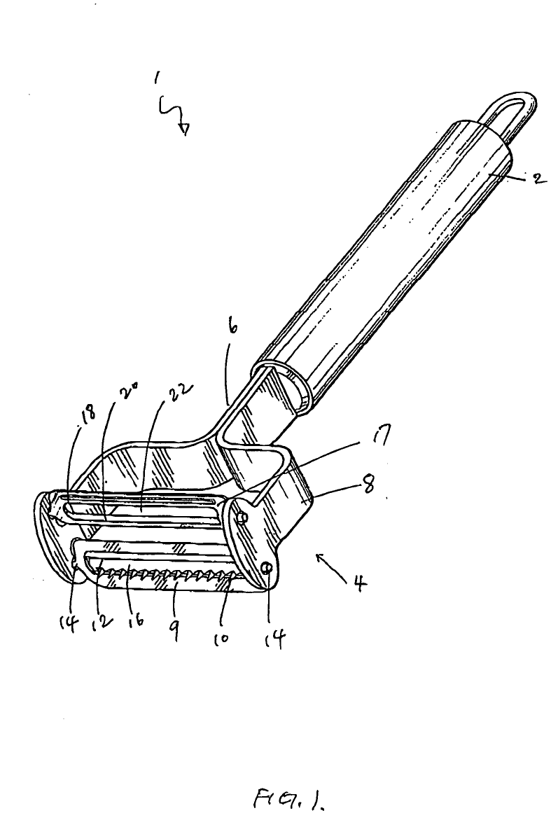

FIG. 1 is a perspective view showing a culinary utensil according to an embodiment of the present invention;

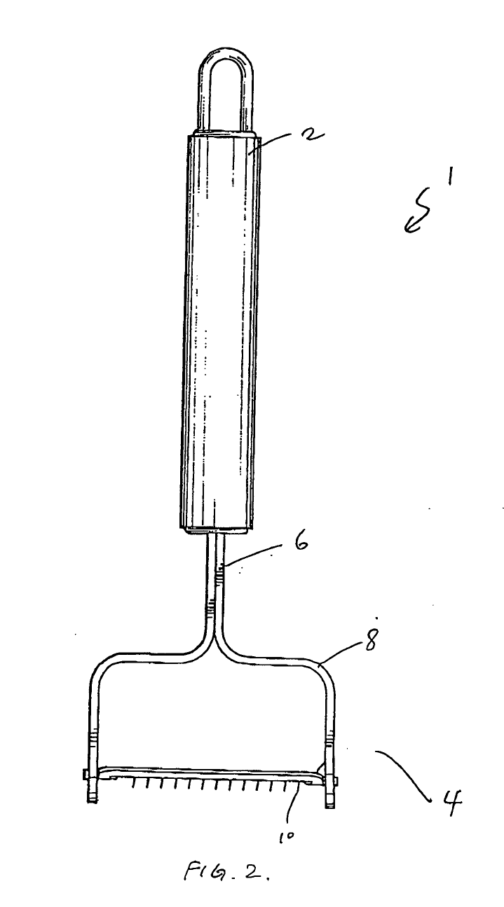

FIG. 2 is a top view of the culinary utensil shown in FIG. 1;

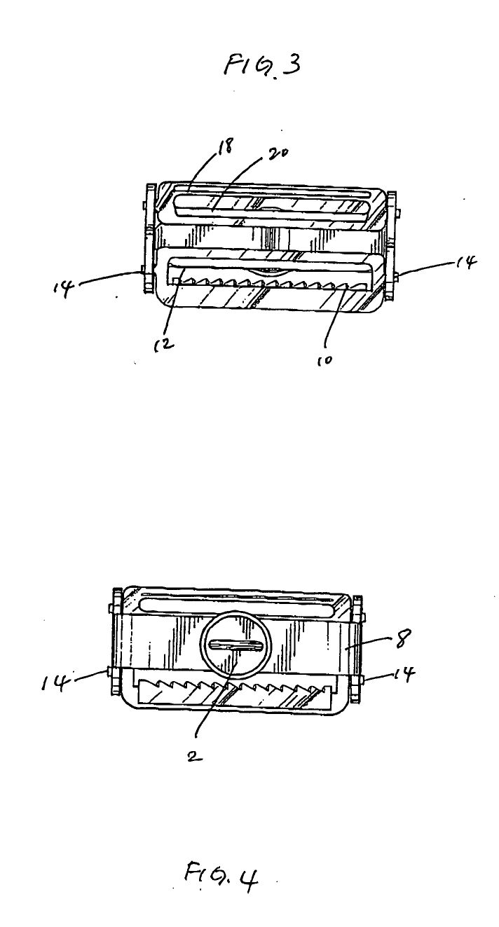

FIG. 3 is a front view of the culinary utensil shown in FIG. 1; and

FIG. 4 is a rear view of the culinary utensil shown in FIG. 1.

Referring to the FIG. 1, the culinary utensil 1 according to the invention is shown, this being a hand tool of relatively compact type which may be used in a kitchen, at home or in a restaurant or supermarket or grocery store.

The utensil 1 designed comprises a handle 2 sized to fit comfortably in a user's hand arranged at one end thereof and a utility portion 4 arranged at the opposite end. A leg 6 extending from the utility portion 4 is received in and fixedly connected to the handle 2. It will be appreciated however that the utility portion 4 may be secured to the handle 2 in other suitable ways, or may be unitarily formed therewith.

The utility portion 4 comprises a U-shaped bracket 8 having two spaced arms, and first and second cutting elements. The first cutting element 9 comprises first and second cutting means which together are of elongate shape and define an opening 16 extending therebewteen along the length thereof. The first cutting means is in the form of a series of sharp teeth 10 protruding from the element arranged edgewise and pointing downwardly away from the handle 2. As best seen in FIGS. 1 and 2, each of the teeth 10 tapes to a point when viewed in the direction of the longitudinal extent of the element 9 and is relatively thin when viewed laterally. Conveniently, the teeth 10 are formed by making a series of short angled cuts in a straight blade-like edge and bending downwardly.

The second cutting means 9 is provided on the first cutting element in the form of a sharp cutting edge 12 arranged extending in a lateral direction on the opposite side of the opening 16. The element 9 is formed opposite ends, with two pins 14 which are received in two respective openings provided at end regions of the arms of the bracket 8, whereby the element 9 is secured for limited pivotal movement relative to the rest of the utensil 1.

A second cutting element 17 is provided with a third cutting means in the form of two opposite cutting edges 18, 20. The third cutting means is also of an elongate shape having a longitudinal opening 22 extending along the length thereof. The cutting edges 18, 20 are of conventional type, each of which may be used for peeling skin from foodstuffs. The second cutting element 17 is also pivotably connected to the arms of the bracket 8 and spaced apart from first cutting element such that movement thereof do not interfere with each other.

When the utensil 1 is used for producing strips of foodstuffs, the utensil 1 is positioned such that the teeth 10 are arranged against the foodstuffs to be cut. In particular, the teeth 10 are pressed into the surface of the foodstuffs so that grooves are cut in the surface as the utensil 1 is moved over the foodstuffs. The sharp cutting edge 12 arranged at the opposite side of the opening 16 engages and cuts into the surface of the foodstuffs in which the grooves have just been formed by the teeth 10, peeling away the upper layer of the foodstuff but in the form of julienne strips. It can be seen that the sharp leading edges of the teeth 10 are substantially parallel to the direction of operation of the utensil 1 in use. It can also be seen that the sharp cutting edge 12 is substantially perpendicular to the direction of operation of the utensil 1 such that in use strips removed from the foodstuffs are substantially parallel to the movement of the handle 2 or the utensil 1.

It will be appreciated that the series of the teeth 10 should preferably be positioned relatively close in the lateral direction of the element to the cutting edge 12 to allow the production of the strips more easily. In the embodiment, the teeth 10 and the sharp cutting edge 12 are spaced apart by about 4 mm although in practice a spacing from about 2 to 10 mm would also be appropriate.

The provision of the sharp cutting edges 18, 20 of the second element allows the utensil 1 also to be used as a regular culinary peeler. A utensil 1 according to the embodiment of the present invention therefore provides a simple and yet useful tool with dual functions.

Although the cutting edges 12, 18, 20 and the series of teeth 10 of the utensil 1 are arranged substantially perpendicular to the handle, it is envisaged that they may alternatively be arranged substantially parallel to the handle 2. A utensil with such arrangement would equally be able to readily cut foodstuffs into a julienne.

1. A culinary utensil provided with a first cutting means in the form of a series of spaced cutting teeth arranged on a first cutting member spaced in a lateral direction, and a second cutting means arranged close to the first cutting means in the form of an elongate cutting edge which extends in the lateral direction.

2. A culinary utensil according to claim 1 wherein the first and second cutting means are both arranged on the first cutting member.

3. A culinary utensil according to claim 2 wherein the first cutting member is provided with an opening arranged along the length thereof, with the first and second cutting means on opposite sides of the opening.

4. A culinary utensil according to claim 1 wherein the cutting teeth are of thin profile when viewed in a direction perpendicular to the lateral direction.

5. A culinary utensil according to claim 3 wherein the teeth are unitarily formed with the first cutting member, being bent downwardly therefrom.

6. A culinary utensil according to claim 1 wherein the first cutting member is secured at opposite ends on the utensil to allow limited pivoting moment.

7. A culinary utensil according to claim 6 wherein the utensil has an elongate handle and a U-shaped support on which the first cutting member is pivotally mounted.

8. A culinary utensil according to claim 7 wherein a second member provided on the U-shaped support formed with at least one cutting edge.

9. A culinary utensil according to claim 8 wherein the second member has two opposed cutting edges on opposite sides of an opening.
